(19) United States
(12) Patent Application Publication
(10) Pub. No.: US 2024/0338810 A1
(43) Pub. Date: Oct. 10, 2024

(54) IMAGE FORMING SYSTEM

(71) Applicant: CANON KABUSHIKI KAISHA, Tokyo (JP)

(72) Inventors: KENJI MORITA, Ibaraki (JP); KENJI KUROKI, Ibaraki (JP)

(21) Appl. No.: 18/626,140

(22) Filed: Apr. 3, 2024

(30) Foreign Application Priority Data
Apr. 7, 2023 (JP) 2023-062989

(51) Int. Cl. G06T 7/00; H04N 1/00

(52) U.S. Cl. CPC G06T 7/0008; H04N 1/00045; H04N 1/00082; G06T 2207/30144

(57) ABSTRACT

An image forming system comprising an image forming apparatus forms an image, a reading apparatus reads the image, an inspection unit inspects the image read by the reading apparatus to detect defect on the image, and a controller configured to control, in a case where a first type of defect is detected by the inspection unit during formation of a plurality of images by the image forming apparatus, the image forming apparatus to stop the formation, and execute an adjustment operation for adjusting a quality of an image to be formed by the image forming apparatus, and control, in a case where a second type of defect is detected by the inspection unit during the formation, the image forming apparatus to continue the formation, wherein the second type of defect is different from the first type of defect.

### BACKGROUND

### Field of the Disclosure

The present disclosure relates to an image forming system for inspecting a document image printed on a sheet.

### Description of the Related Art

United States Patent Application Publication No. 2022/0179600 discusses an image forming system which forms an adjustment chart on a sheet, and executes an adjustment operation to adjust an image forming condition based on a read result of the adjustment chart in a case where image defects occurs in images continuously.

The image defects include a defect resulting from positional deviation, in which a position of an image formed on a sheet is deviated from an ideal position, and a defect resulting from formation of a streak-like image, in which a streak-like image which does not exist in an image is included in the image formed on a sheet. Although the positional deviation can be corrected by the adjustment operation, the streak-like image is not always reduced even if the adjustment operation is executed. In other words, according to the technique discussed in United States Patent Application Publication No. 2022/0179600, there is a possibility that the adjustment operation is executed even in a case where the image defect has occurred because of the streak-like image which cannot be reduced by the adjustment operation.

### SUMMARY

According to an aspect of the present disclosure, an image forming system includes an image forming apparatus configured to form an image on a sheet, a reading apparatus configured to read the image formed on the sheet conveyed from the image forming apparatus, an inspection unit configured to inspect the image read by the reading apparatus to detect defect on the image, and a controller configured to control, in a case where a first type of defect is detected by the inspection unit during formation of a plurality of images by the image forming apparatus, the image forming apparatus to stop the formation, and execute an adjustment operation for adjusting a quality of an image to be formed by the image forming apparatus, and control, in a case where a second type of defect is detected by the inspection unit during the formation of the plurality of images by the image forming apparatus, the image forming apparatus to continue the formation, wherein the second type of defect is different from the first type of defect.

Further features of the present disclosure will become apparent from the following description of exemplary embodiments with reference to the attached drawings.

### BRIEF DESCRIPTION OF THE DRAWINGS

FIG. 1 is a cross-sectional diagram of an image forming system.

FIG. 2 is a block diagram illustrating a configuration of a control apparatus.

FIG. 3 is a block diagram illustrating a configuration of an inspection controller.

FIG. 4 is a diagram illustrating a print setting screen.

FIG. 5 is a diagram illustrating an inspection setting screen.

FIG. 6 is a diagram illustrating an example of an adjustment chart.

FIG. 7 is a flowchart illustrating image inspection control according to one or more aspects of the present disclosure.

FIG. 8 is a diagram illustrating a screen for selecting whether to execute image adjustment control.

FIG. 9 is a flowchart illustrating image inspection control according to one or more aspects of the present disclosure.

FIG. 10 is a flowchart illustrating image inspection control according to one or more aspects of the present disclosure.

FIG. 11 is a diagram illustrating a configuration of a fixing device.

FIG. 12 is a diagram illustrating a configuration of an inspection apparatus.

FIG. 13 is a diagram illustrating a screen for prompting a user to clean dirt.

FIG. 14 is a diagram illustrating a method for determining a cause of a streak-like image.

FIGS. 15A and 15B are a flowchart illustrating image inspection control according to one or more aspects of the present disclosure.

### DESCRIPTION OF THE EMBODIMENTS

Exemplary embodiments of the present disclosure are described with reference to the appended drawings. Shapes and relative arrangement of constituent elements described in the following exemplary embodiments should be changed as appropriate depending on a configuration and various conditions of an apparatus to which the present disclosure is applied, and the scope of the present disclosure should not be limited to the exemplary embodiments described below.

### <Image Forming System>

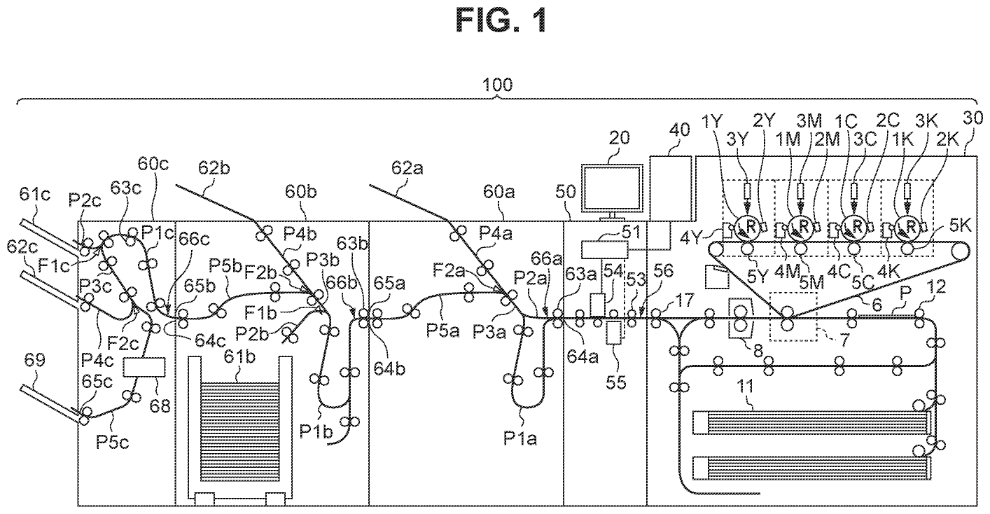

FIG. 1 is a cross-sectional diagram of an image forming system 100 employed in the present exemplary embodiment. The image forming system 100 includes an operation unit 20, an electrophotographic color copying machine (hereinafter, called “image forming apparatus”) 30, a control apparatus 40, an inspection apparatus 50 serving as a reading apparatus, and stacking apparatuses 60a, 60b, and 60c. Each of the image forming apparatus 30, the inspection apparatus 50, and the stacking apparatuses 60a, 60b, and 60c has a separate housing. The number of stacking apparatuses 60 may be one or more.

A recording method of the image forming apparatus 30 is not limited to an electrophotographic method, and can be another recording method such as an ink-jet method. Further, a recording format of the image forming apparatus 30 can be a monochrome format or a color format.

A configuration and a function of the image forming system 100 are described below with reference to FIG. 1.

### <Image Forming Apparatus>

A sheet storage tray 11 for storing sheets is arranged on the inner portion of the image forming apparatus 30. The sheets refer to recording materials on which images are formed by the image forming apparatus 30. For example, sheets of paper, resin sheets, fabrics, overhead projector (OHP) sheets, and labels are included in the sheets.

Each of the sheets stored in the sheet storage tray 11 is sent by pick-up rollers and conveyed by conveyance rollers 12.

Image signals input to the image forming apparatus 30 are input to light scanning devices 3Y, 3M, 3C, and 3K for each of color components, and each of the light scanning devices 3Y, 3M, 3C, and 3K includes a semiconductor laser and a polygon mirror. Specifically, an image signal for a yellow color component is input to the light scanning device 3Y, and an image signal for a magenta color component is input to the light scanning device 3M. Further, an image signal for a cyan color component is input to the light scanning device 3C, and an image signal for a black color component is input to the light scanning device 3K. Although the present exemplary embodiment is described with respect to formation of a yellow image, the same can also be said for formation of magenta, cyan, and black images.

An outer circumferential surface of a photosensitive drum 1Y is electrically charged by a charging device 2Y. After the outer circumferential surface of the photosensitive drum 1Y is charged electrically, laser light according to the input image signal is emitted to the outer circumferential surface of the photosensitive drum 1Y from the light scanning device 3Y via an optical system such as a polygon mirror and a mirror. As a result, an electrostatic latent image is formed on the outer circumferential surface of the photosensitive drum 1Y.

Subsequently, the electrostatic latent image is developed with toner included in a development device 4Y serving as a development unit, so that a toner image is formed on the outer circumferential surface of the photosensitive drum 1Y. The toner image formed on the photosensitive drum 1Y is transferred to a transfer belt 6 serving as an intermediate transfer body by a transfer roller 5Y arranged at a position opposite to the photosensitive drum 1Y.

Toner images of respective colors of yellow, magenta, cyan, and black transferred to the transfer belt 6 are transferred to a sheet by a secondary transfer unit 7.

A sheet on which a toner image is transferred as described above is conveyed to a fixing device 8 and heated and pressurized thereby, so that the toner image is fixed to the sheet. As described above, an image is formed on the sheet by the image forming apparatus 30.

### <Inspection Apparatus>

The inspection apparatus 50 reads an image formed on a sheet conveyed from the image forming apparatus 30 to inspect quality of the image. In other words, the inspection apparatus 50 inspects whether the image formed on the sheet satisfies an inspection criterion.

An image formed on a sheet conveyed by conveyance rollers 53 is read by image sensors 54 and 55 at a reading position. Each of the image sensors 54 and 55 includes a light source for illuminating the sheet and a complementary metal-oxide semiconductor (CMOS) sensor. After the image is read thereby, the sheet is discharged to a stacking apparatus 60a.

The stacking apparatus 60a receives sheets discharged from the inspection apparatus 50 via an inlet port 64a, and discharges the sheets to the sheet tray 62a, or discharges the sheets from an outlet port 65a.

A branched portion of a conveyance path P1a and a conveyance path P2a exists in the downstream of the inlet port 64a. A flapper (not illustrated) is arranged at the branched portion, and guides a sheet to the conveyance path P1a or the conveyance path P2a. The conveyance paths P1a and P2a are connected to a conveyance path P3a.

The conveyance path P3a is branched into a conveyance path P4a and a conveyance path P5a at a branched position where a flapper F2a is arranged. A sheet conveyed through the conveyance path P3a is guided to the conveyance path P4a or the conveyance path P5a by the flapper F2a.

A sheet tray 62a is arranged at an outlet port of the conveyance path P4a. For example, a sheet which the inspection apparatus 50 has determined as a sheet of rejected image quality (i.e., a rejected sheet which does not satisfy the inspection criterion) is stacked on the sheet tray 62a. The sheet determined as a sheet of rejected image quality may be discharged to an apparatus for executing subsequent processing from the outlet port 65a. Further, a sheet determined as “OK”, (i.e., an acceptable sheet which satisfies the inspection criterion) may be stacked (discharged) onto the sheet tray 62a. The conveyance path P5a is arranged to extend to the outlet port 65a.

The stacking apparatus 60b receives the sheets discharged from the stacking apparatus 60a via an inlet port 64b, and stacks (discharges) the sheets onto the sheet tray 61b or 62b, or discharges the sheets from an outlet port 65b.

A conveyance path P1b extending from the inlet port 64b is branched into a conveyance path P2b and a conveyance path P3b at a branched position where a flapper F1b is arranged. A sheet conveyed through the conveyance path P1b is guided to the conveyance path P2b or the conveyance path P3b by the flapper F1b.

A sheet tray 61b is arranged at an outlet port of the conveyance path P2b. The sheet tray 61b is a large-volume sheet stacking unit on which a large volume of sheets can be stacked. For example, a sheet that has passed the image inspection (quality inspection) is stacked on the sheet tray 61b.

A conveyance path P3b is branched into a conveyance path P4b and a conveyance path P5b at a branched position where a flapper F2b is arranged. A sheet conveyed through the conveyance path P3b is guided to the conveyance path P4b or the conveyance path P5b by the flapper F2b.

A sheet tray 62b is arranged at an outlet port of the conveyance path P4b. For example, a sheet which the inspection apparatus 50 has determined as a sheet of rejected image quality is stacked on the sheet tray 62b. The sheet determined as a sheet of rejected image quality may be discharged to an apparatus for executing the subsequent processing from the outlet port 65b. Further, a sheet determined as “OK”, (i.e., an acceptable sheet which satisfies the inspection criterion) may be stacked on the sheet tray 62b. The conveyance path P5b is arranged to extend to the outlet port 65b.

An apparatus for executing the subsequent processing may be connected to the outlet port 65b. Further, as with the case of the stacking apparatus 60c, a sheet tray 69 may be arranged at the outlet port 65c. A sheet determined as a sheet of rejected image quality or a sheet determined as a sheet of acceptable image quality can also be stacked on the sheet tray 69. As described above, a type of sheets discharged to sheet trays 61b, 61c, 62a, 62b, 62c, and 69 can previously be determined based on the user setting.

The sheet trays 61c, 62c, and 69 arranged on the stacking apparatus 60c may respectively be called an upper tray, a middle tray, and a lower tray. A post-processing unit 68 may include a binding processing unit which creates a bundle of sheets by bundling the sheets discharged from the stacking apparatus 60b and binds the bundle of sheets with a stapler. The post-processing unit 68 may include a bookbinding processing unit for folding the bundle of sheets in half. The post-processing unit 68 may include a cutting processing unit for cutting the bundle of sheets.

One or more conveyance rollers 63 are arranged on each of the conveyance paths P1, P2, P3, P4, and P5. The conveyance rollers 63 conveys a sheet to a downstream from an upstream in the conveyance direction of the sheet. The conveyance rollers 63 can be a pair of rollers consisting of two rollers which convey the sheet while holding the sheet therebetween.

The number of stacking apparatuses 60 connected to the downstream side of the inspection apparatus 50 may be one or more. Further, the number of sheet trays 61, 62, and 69 arranged on the stacking apparatuses 60 connected to the downstream side of the inspection apparatus 50 may be two or more in total. Further, the number of flappers F1 and the number of flappers F2 may be one or more.

### [Control Configuration]

### <Control Apparatus>

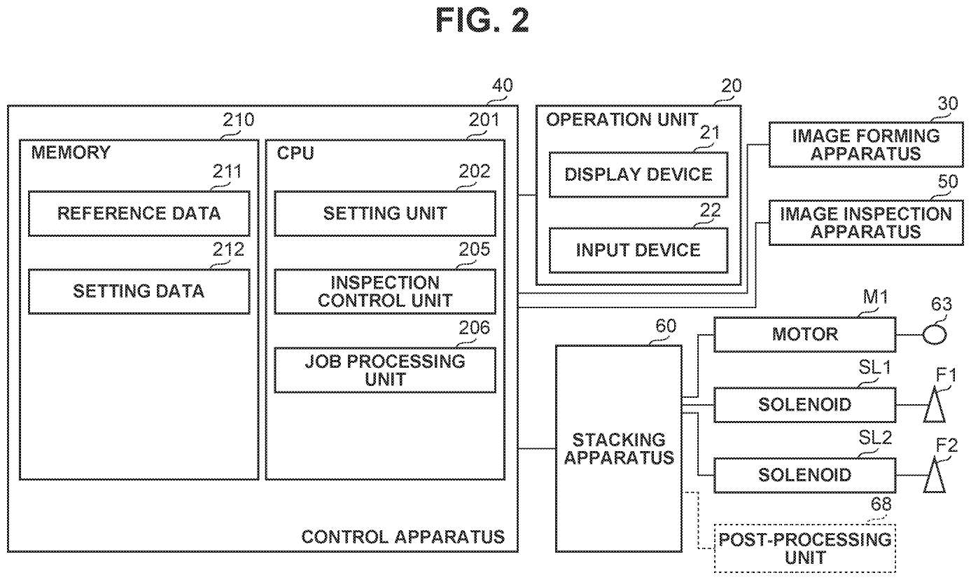

FIG. 2 is a block diagram illustrating a configuration of the control apparatus 40. The control apparatus 40 includes at least one application specific integrated circuit (ASIC), and executes functions described below.

The operation unit 20 includes a display device 21 serving as a display unit for outputting information to the user and an input device 22 (e.g., touch panel sensor) for receiving instructions from the user. The operation unit 20 may include an audio circuit and a speaker for outputting messages to the user.

For example, a setting unit 202 accepts settings of sheet information, an inspection item, and an inspection level. The sheet information includes a type of the sheet and a length of the sheet in a conveyance direction (also called a lengthwise direction). The inspection level indicates a degree of strictness of the image inspection. The setting unit 202 stores setting data 212 which describes information about the image inspection, such as the sheet information, inspection details, and the inspection level which the user has set via the display device 21, in a memory 210.

Reference data 211 is stored in the memory 210. The reference data 211 is image data of a reference image used as a reference for the image inspection. For example, the reference data 211 may be document image data (raster image processing (RIP) image data) associated with a print job received from a host computer existing in the outside of the image forming system 100. Further, for example, the reference data 211 may be image data acquired by reading one or a plurality of sheets on which images corresponding to reference images are formed.

An inspection control unit 205 controls the inspection apparatus 50 based on the setting data 212. For example, when the inspection control unit 205 receives a request for the reference data 211 from the inspection apparatus 50, the inspection control unit 205 transmits the reference data 211 to the inspection apparatus 50. Further, the inspection control unit 205 acquires information about an inspection result of the image from the inspection apparatus 50. Based on the inspection result, the inspection control unit 205 controls the flappers F1 and F2 to discharge a sheet to any one of the sheet trays 61 62, and 69 specified by the user.

A job processing unit 206 executes control of a print job for printing the images on the sheets, a stacking job for stacking a bundle of sheets on the stacking apparatuses 60a and 60b, and a post-processing job of a bundle of sheets executed at the stacking apparatus 60c. The job processing unit 206 may store job data (job information) necessary to execute the above-described jobs in the memory 210.

According to a control command from the job processing unit 206, the stacking apparatus 60 drives a motor M1 to rotate the conveyance rollers 63. The stacking apparatus 60 also drives a solenoid SL1 or SL2 depending on a control command from the job processing unit 206 to change a direction of the flapper F1 or F2. With this operation, a sheet is guided and conveyed to any one of the sheet trays 61, 62, and the stacking apparatus 60c. For example, in a case where the inspection result of the image acquired by the inspection apparatus 50 is “NG”, the job processing unit 206 controls the stacking apparatus 60 to discharge a sheet determined as “NG” to the sheet tray 62. Although the image forming apparatus 30 also includes a solenoid for driving a flapper and a motor for driving conveyance rollers, these elements are not illustrated.

### <Inspection Apparatus>

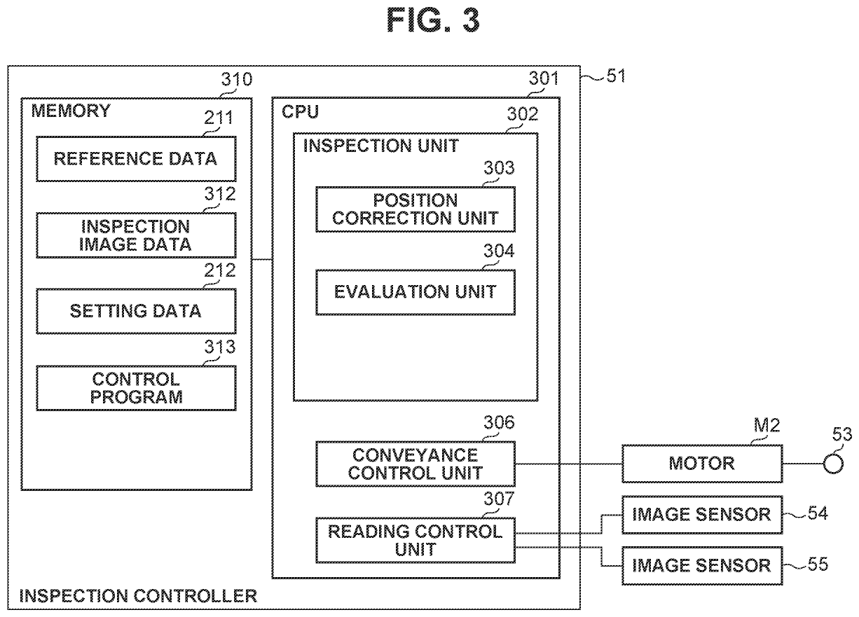

FIG. 3 is a block diagram illustrating a configuration of an inspection controller 51 arranged on the inspection apparatus 50. The inspection controller 51 includes at least one ASIC, and executes functions described below.

An inspection unit 302 executes image inspection based on the setting data 212 received from the control apparatus 40 and transmits an inspection result to the control apparatus 40. In addition, the inspection may be executed by a central processing unit (CPU) 201, or may be executed by a personal computer (PC) externally connected to the image forming system 100.

A position correction unit 303 executes correction of a position on the read result acquired by the image sensors 54 and 55. In a case where the sheet is obliquely placed and read by the image sensors 54 and 55, the sheet may obliquely be laid out in a read image. Therefore, the position correction unit 303 corrects the position of the sheet in the read result (i.e., read image) by rotating the read result or by shifting the coordinates thereof.

Inspection image data (read image data) 312 is image data created by reading a sheet by the image sensors 54 and 55. An evaluation unit 304 compares the inspection image data 312 with the reference data 211 to determine whether the image formed on the sheet satisfies the inspection criterion. In other words, the evaluation unit 304 functions as an inspection unit.

For example, in a case where an inspection item is “positional deviation”, the evaluation unit 304 determines that the image is acceptable (i.e., the image has no defect) if an amount of deviation of a position of the image in the inspection image data 312 from a position of the image in the reference data 211 is a prescribed value or less. If the amount of deviation is greater than the prescribed value, the evaluation unit 304 determines that the image is rejected (i.e., the image has a defect). In other words, the image satisfies the inspection criterion if an amount of deviation of a position of the image in the inspection image data 312 from a position of the image in the reference data 211 is a prescribed value or less. Further, the image does not satisfy the inspection criterion if an amount of deviation of a position of the image in the inspection image data 312 from a position of the image in the reference data 211 is greater than the prescribed value. In addition, an absolute position of the image in the inspection image data 312 with respect to an edge of the sheet may be inspected.

Further, in a case where an inspection item is “a black dot”, the evaluation unit 304 determines that the image is acceptable if a black dot which exists in the image of the inspection image data 312 but does not exist in the image in the reference data 211 has a size less than or equal to a determination threshold. In other words, a black dot corresponds to a noise image which exists in the image corresponding to the inspection image data 312 on which reduction processing is executed but does not exist in the image corresponding to the reference data 211. The evaluation unit 304 determines that the image is rejected if a size of the black dot is greater than the determination threshold. In other words, the image satisfies the inspection criterion if a size of the black dot is not greater than the determination threshold. Further, the image does not satisfy the inspection criterion if a size of the black dot is greater than the determination threshold.

Further, in a case where an inspection item is “a streak”, for example, the evaluation unit 304 determines that the image is acceptable if a streak-like image extending in a conveyance direction has a length shorter than a prescribed length. Then, the evaluation unit 304 determines that the image is rejected if a streak-like image extending in a conveyance direction has a length longer than or equal to the prescribed length. In other words, the image satisfies the inspection criterion if a streak-like image extending in a conveyance direction has a length shorter than a prescribed length. Further, the image does not satisfy the inspection criterion if a streak-like image extending in a conveyance direction has a length longer than or equal to the prescribed length.

Further, in a case where the inspection item is “a color”, for example, the evaluation unit 304 executes inspection of a color based on a difference value between red (R) image data (luminance data) in the reference data 211 and R image data (luminance data) in the inspection image data 312. More specifically, the evaluation unit 304 determines that the image is rejected if a difference value is greater than or equal to a prescribed value. Further, the evaluation unit 304 determines that the image is acceptable if a difference value is less than the prescribed value. In other words, the image satisfies the inspection criterion if the difference value is less than the prescribed value. Further, the image does not satisfy the inspection criterion if the difference value is greater than or equal to the prescribed value. Processing similar to the above-described processing is also executed with respect to the colors of green (G) and blue (B).

As described above, in the present exemplary embodiment, the image sensors 54 and 55 are used for positioning adjustment control and quality inspection of the image formed by the image forming apparatus 30. For example, the evaluation unit 304 determines that the image is acceptable in a case where a difference between the pixel values of image data corresponding to the reference data 211 and the inspection image data 312 is less than a prescribed value. Further, the evaluation unit 304 determines that the image is rejected in a case where a difference between the pixel values of the reference data 211 (reference image data) and the inspection image data 312 is greater than or equal to the prescribed value. In other words, the image satisfies the inspection criterion in a case where a difference between the pixel values of the reference data 211 (reference image data) and the inspection image data 312 is less than the prescribed value. Further, the image does not satisfy the inspection criterion in a case where a difference between the pixel values of the reference data 211 (reference image data) and the inspection image data 312 is greater than or equal to the prescribed value.

A conveyance control unit 306 drives a motor M2 to rotate the conveyance rollers 53. A reading control unit 307 reads the sheet by controlling the image sensors 54 and 55, and generates the inspection image data 312. The image sensor 54 reads a first face of the sheet, and the image sensor 55 reads a second face of the sheet. With this configuration, the inspection apparatus 50 of the present exemplary embodiment can execute image inspection on both of the faces of the sheet.

### [Setting Screen]

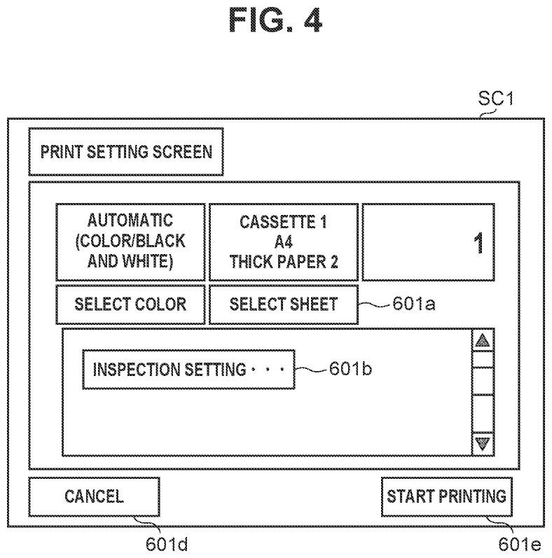

FIG. 4 is a diagram illustrating a print setting screen SC1. The user operates a button 601a to specify a size and a grammage of the sheet as a printing target and the sheet storage tray 11. The print setting screen SC1 is shifted to an inspection setting screen SC2 when a button 601b is operated. The setting details are cancelled when a button 601d is operated. The screen is shifted to a prescribed initial screen when the button 601d is operated by an operator (user). Printing is started when a button 601e is operated.

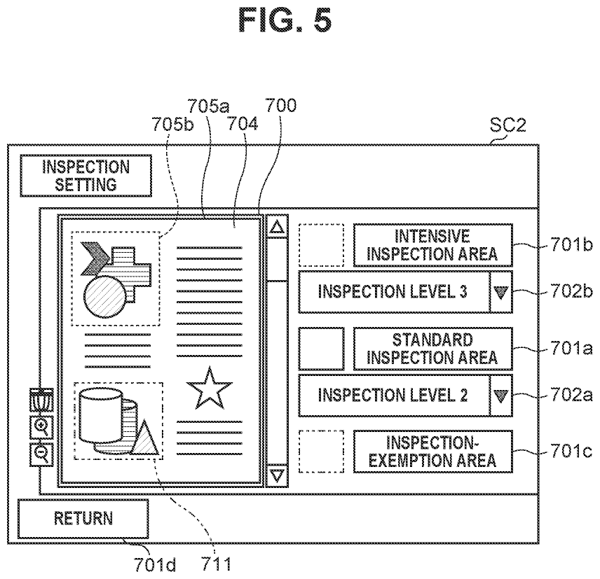

FIG. 5 is a diagram illustrating the inspection setting screen SC2. The inspection setting screen SC2 is a screen which allows the operator to input instructions to set an inspection area 705 where quality inspection is executed by the inspection apparatus 50. As illustrated in FIG. 5, an image 704 as a printing target, inspection areas 705a and 705b, and an inspection-exemption area 711 are displayed on a display area 700.

The inspection areas 705a and 705b, and the inspection-exemption area 711 are set through the operation of a mouse or a touch panel serving as a part of the constituent elements of the input device 22. The inspection area 705a is a standard inspection area set through the operation of the button 701a. For example, the standard inspection area is an inspection area where standard inspection is executed. A menu 702a is a pull-down menu for setting an inspection level (inspection precision) applied to the inspection area 705a. In this example, an inspection level 1 corresponds to the lowest level of inspection precision, and the inspection precision becomes higher (i.e., the inspection becomes stricter) as the level number becomes greater.

The inspection area 705b is an intensive inspection area set through the operation of a button 701b. For example, the intensive inspection area is an inspection area where inspection is executed with high precision. In the example illustrated in FIG. 5, highly precise inspection is executed with respect to the figures such as a round shape and a cross shape.

A menu 702b is a pull-down menu for setting an inspection level (inspection precision) applied to the inspection area 705b. The pull-down menu may also be called a drop-down list.

The inspection-exemption area 711 is an area where inspection is not executed. The inspection-exemption area 711 is set through the operation of a button 701c. It is not necessary to execute highly precise inspection with respect to a cylindrical shape and a triangular shape. Therefore, an area which includes these figures may be specified as an inspection-exemption area. As described above, an inspection level can be set for each of the areas included in a printing target. Therefore, the user can set an appropriate acceptance criterion. As a result, the frequency of useless reprinting is reduced because printed matter of allowable quality is determined as acceptable, so that the productivity is improved. Further, the frequency of wasteful disposal of sheets can also be reduced.

The screen is brought back to the original screen, i.e., the print setting screen SC1, when a button 701d is operated. The button 701d may be provided as a cancel button. In this case, the inspection setting input to the inspection setting screen SC2 is cancelled when the button 701d is pressed. In a case where the button 701d is provided as a cancel button, an OK button for enabling the inspection setting and bringing the screen back to the print setting screen SC1 is also provided.

### [Image Adjustment Control]

In the present exemplary embodiment, adjustment control of a position and density of an image formed by the image forming apparatus 30 (i.e., image adjustment control) is executed based on the read result acquired by the image sensors 54 and 55. In the image adjustment control, the CPU 201 controls the image forming apparatus 30 to form a predetermined adjustment chart on a sheet. As a result, the image forming apparatus 30 forms the adjustment chart on a sheet.

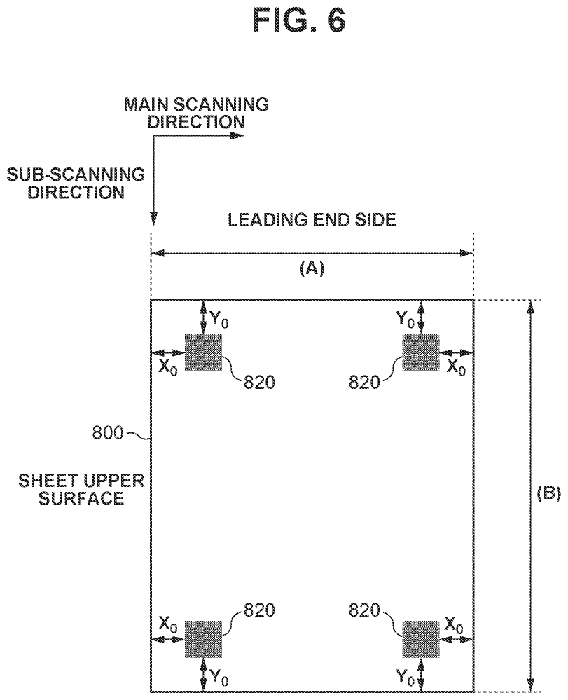

FIG. 6 is a schematic diagram illustrating a state where an adjustment chart used as a test chart is printed on a sheet. As illustrated in FIG. 6, the adjustment chart includes marks 820 arranged at four corners of the sheet. Each of the marks 820 is arranged at a position separated by Yo and Xo from an edge portion in a conveyance direction (corresponding to a sub-scanning direction) and an edge portion in a width direction (corresponding to a main scanning direction orthogonal to the sub-scanning direction) of the sheet. Although patch-shaped marks 820 used for the adjustment of a position of an image are formed on the adjustment chart illustrated in FIG. 6, publicly-known trim marks may be used as the marks for adjusting a position of the image. Further, although the marks 820 used for the adjustment of a position of the image are formed on the adjustment chart illustrated in FIG. 6, patches used for the adjustment of density of the image may also be formed in addition to the marks 820.

A sheet on which the adjustment chart (FIG. 6) is formed by the image forming apparatus 30 is conveyed to the inspection apparatus 50. The inspection apparatus 50 reads the image of the sheet on which the adjustment chart is formed.

The CPU 201 calculates a distance between a sheet edge position and a position of the mark 820 and a relative positional relationship between respective marks 820 in the image acquired by the image sensors 54 and 55 by reading the adjustment chart. Further, based on a calculated distance (Xo, Yo) and a calculated relative positional relationship, the CPU 201 generates an image forming condition for adjustment of a position, an inclination angle, and a magnification ratio of the image formed on the sheet.

In other words, the CPU 201 adjusts the positional deviation by generating an image forming condition for forming of the image on the sheet based on a read image of the sheet on which the adjustment chart (FIG. 6) is formed. In addition, for example, the image forming condition for adjustment of the positional deviation may be generated by an image processor (not illustrated) of the image forming apparatus 30 based on the read image of the sheet on which the adjustment chart (FIG. 6) is formed. In this case, the CPU 201 issues an instruction to form the adjustment chart (FIG. 6), acquires the read image of the sheet on which the adjustment chart (FIG. 6) is formed, and transmits the read image to the image processor (not illustrated) of the image forming apparatus 30. The CPU 201 at least functions as a controller for executing the adjustment operation for forming of the adjustment chart used for the adjustment of positional deviation.

Further, in a case where the patches used for the adjustment of the density of the image are formed as another adjustment chart, the CPU 201 calculates a difference between density of the patch and target density of the patch based on the read image acquired by the image sensors 54 and 55 by reading the adjustment chart, and generates the image forming condition for adjustment of the density of the image formed on the sheet such that the difference becomes smaller. In addition, for example, the image forming condition for the adjustment of the density of the image may be generated by an image processor (not illustrated) of the image forming apparatus 30 based on the read image of the patch. In other words, the CPU 201 adjusts the density of the image by generating the image forming condition for forming of the image on the sheet based on the read image of the sheet on which the patches are formed. In this case, the CPU 201 issues an instruction to form the patches, acquires the read image of the patches formed on the sheet, and transmits the read image to the image processor (not illustrated) of the image forming apparatus 30. The CPU 201 at least functions as a controller for executing the adjustment operation for forming of the patches used for the adjustment of the density of the image.

### <Execution Timing of Image Adjustment Control>

Next, an execution timing of image adjustment control according to the present exemplary embodiment is described. According to the present exemplary embodiment, generation of waste sheets can be suppressed by application of the following configuration.

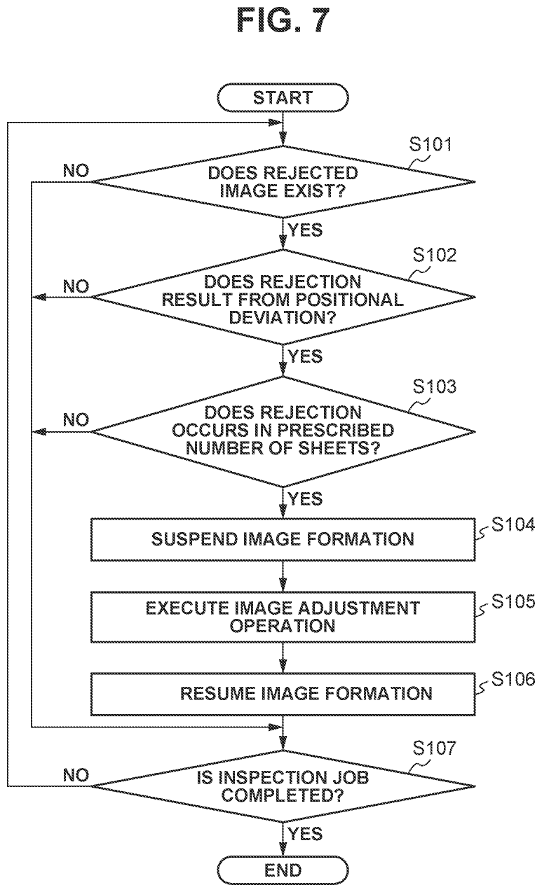

FIG. 7 is a flowchart illustrating image inspection control including the image adjustment control. The flowchart in FIG. 7 is executed by the CPU 201 when an inspection job for inspecting the images formed on the sheets is executed. The inspection job according to the present exemplary embodiment is a print job which includes image inspection. In the image inspection control illustrated in FIG. 7, descriptions of the processing for forming the images on the sheets executed by the image forming apparatus 30 and the processing for reading the images formed on the sheets executed by the inspection apparatus 50 are omitted. For example, the sheets on which the images are formed by the image forming apparatus 30 are sequentially read by the inspection apparatus 50 while a print job (inspection job) for printing a plurality of images on a plurality of sheets is being executed by the image forming apparatus 30. In the following descriptions, a CPU 201 of the control apparatus 40 executes the image inspection control while a print job (inspection job) for printing a plurality of images on a plurality of sheets is being executed by the image forming apparatus 30.

In step S101, in a case where the evaluation unit 304 determines that an image formed on a sheet is rejected (YES in step S101), the processing proceeds to step S102.

On the other hand, in a case where the evaluation unit 304 does not determine that an image formed on a sheet is rejected (NO in step S101), the processing proceeds to step S107.

In step S102, in a case where the details of rejection are “positional deviation” (YES in step S102), the processing proceeds to step S103.

On the other hand, in step S102, in a case where the details of rejection are not “positional deviation” (NO in step S102), the processing proceeds to step S107.

In step S103, in a case where the rejection whose details are “positional deviation” occurs in a prescribed number of sheets (e.g., 5 sheets) (YES in step S103), the processing proceeds to step S104. In step S104, the CPU 201 suspends (stops) the processing for forming the images on the sheets executed by the image forming apparatus 30. Then, the CPU 201 controls the various apparatuses to make the sheets remaining in the image forming system 100 be discharged to the outside, such as the sheet tray 62a.

On the other hand, in step S103, in a case where the rejection whose details are “positional deviation” does not occur in a prescribed number of sheets (NO in step S103), the processing proceeds to step S107.

In step S105, the CPU 201 executes the image adjustment operation. Specifically, the CPU 201 controls the image forming apparatus 30 to form an adjustment chart on a sheet, and controls the inspection apparatus 50 to read the adjustment chart formed thereon. Based on the read result acquired by the inspection apparatus 50, the image forming apparatus 30 sets the image forming condition again through the method described above.

Thereafter, in step S106, the CPU 201 resumes the inspection job (i.e., resumes the formation of the images on the sheets).

In step S107, in a case where the inspection job is completed (YES in step S107), the CPU 201 ends the processing illustrated in this flowchart.

Further, in step S107, in a case where the inspection job is not completed (NO in step S107), the processing returns to step S101.

As described above, according to the present exemplary embodiment, the image adjustment control is executed in a case where rejection whose details are a first defect, i.e., “positional deviation”, has occurred in a prescribed number of sheets. However, the image adjustment control is not executed even if rejection whose details are a second defect, i.e., “a black dot” or “a streak-like image” as a noise image, has occurred in a prescribed number of sheets. Therefore, image adjustment control is not executed in a case where the details of rejection are “a black dot” or “a streak-like image”. In other words, according to the present exemplary embodiment, the image adjustment control is executed in a case where the evaluation unit 304 determines that there occurs rejection caused by the inspection item which can be corrected by the image adjustment control, and the image adjustment control is not executed when the evaluation unit 304 determines that there occurs rejection caused by the inspection item which cannot be corrected by the image adjustment control. As a result, it is possible to prevent a situation where the adjustment operation is executed even if the image defect has occurred because of a streak-like image which cannot be reduced by the adjustment operation. Therefore, it is possible to suppress generation of waste sheets.

In the present exemplary embodiment, the image adjustment control is executed in a case where rejection whose details are “positional deviation” has occurred in a prescribed number of sheets. However, the present disclosure is not limited thereto. For example, the image adjustment control may be executed in a case where rejection whose details are “positional deviation” has consecutively occurred in a prescribed number of sheets.

Further, for example, the image adjustment control may be executed in a case where rejection whose details are “positional deviation” has occurred in a sheet. In addition, this prescribed number can be set by the user through the input device 22.

Descriptions of the configuration of the image forming system 100 similar to the configuration described in the first exemplary embodiment are omitted.

Hereinafter, image adjustment control according to the present exemplary of waste sheets can be suppressed by application of the following configuration.

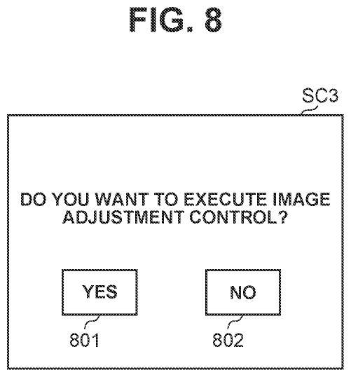

FIG. 8 is a diagram illustrating a screen for allowing a user to select whether to execute the image adjustment control. The CPU 201 executes the image adjustment control when a button 801 is selected. Further, the CPU 201 does not execute the image adjustment control when a button 802 is selected.

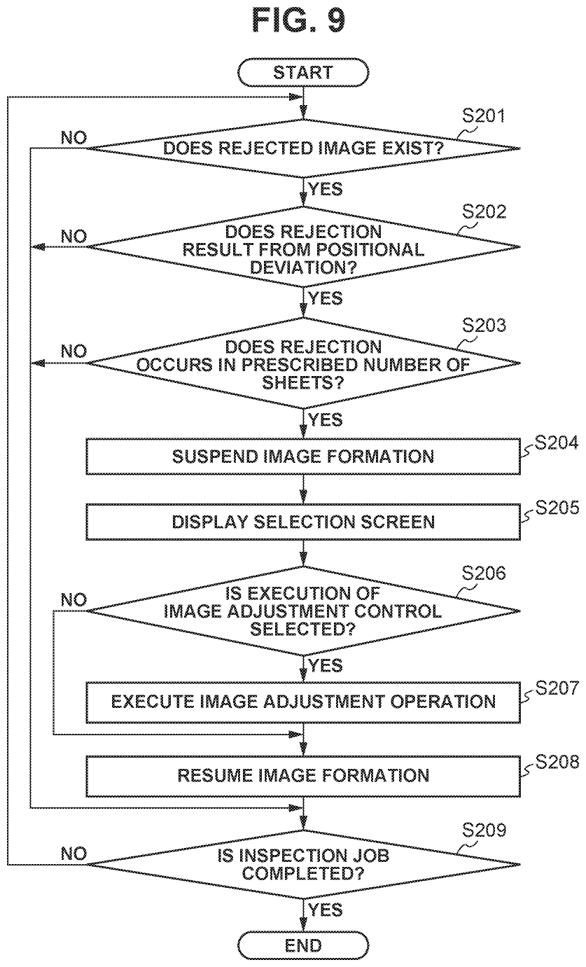

FIG. 9 is a flowchart illustrating image inspection control including the image adjustment control. The flowchart in FIG. 9 is executed by the CPU 201 when an inspection job for inspecting the images formed on the sheets is executed. The inspection job according to the present exemplary embodiment is a print job which includes image inspection. In the image inspection control illustrated in FIG. 9, descriptions of the processing for forming the images on the sheets executed by the image forming apparatus 30 and the processing for reading the images formed on the sheets executed by the inspection apparatus 50 are omitted. For example, the sheets on which the images are formed by the image forming apparatus 30 are sequentially read by the inspection apparatus 50 while a print job (inspection job) for printing a plurality of images on a plurality of sheets is being executed by the image forming apparatus 30. In the following descriptions, the CPU 201 of the control apparatus 40 executes the image inspection control while a print job (inspection job) for printing a plurality of images on a plurality of sheets is being executed by the image forming apparatus 30.

The processing in steps S201 to S204 is similar to the processing in steps S101 to S104 in FIG. 7. Therefore, descriptions thereof are omitted.

In step S205, the CPU 201 displays a selection screen on the display device 21.

In step S206, in a case where the button 801 is selected (YES in step S206), the processing proceeds to step S207. In step S207, the CPU 201 executes the image adjustment operation. Specifically, the CPU 201 controls the image forming apparatus 30 to form the adjustment chart on a sheet, and controls the inspection apparatus 50 to read the adjustment chart formed thereon. Based on the read result acquired by the inspection apparatus 50, the image forming apparatus 30 sets the image forming condition again through the method described above.

On the other hand, in step S206, in a case where the button 802 is selected (NO in step S206), the processing proceeds to step S208.

The processing in steps S208 and S209 is similar to the processing in steps S106 and S107 in FIG. 7. Therefore, descriptions thereof are omitted.

As described above, according to the present exemplary embodiment, the CPU 201 displays a screen (selection screen) illustrated in FIG. 8 in a case where rejection whose details are “positional deviation” has occurred in a prescribed number of sheets. However, the selection screen is not displayed even if rejection whose details are “a black dot” or “a streak-like image” has occurred in a prescribed number of sheets. In other words, the selection screen is not displayed in a case where the details of rejection are “a black dot” or “a streak-like image”. In other words, according to the present exemplary embodiment, the selection screen is displayed in a case where the evaluation unit 304 determines that there occurs rejection caused by the inspection item which can be corrected by the image adjustment control, and the selection screen is not displayed in a case where the evaluation unit 304 determines that there occurs rejection caused by the inspection item which cannot be corrected by the image adjustment control. As a result, it is possible to prevent a situation where the adjustment operation is executed even if the image defect has occurred because of a streak-like image which cannot be reduced by the adjustment operation. Therefore, it is possible to suppress generation of waste sheets.

Descriptions of the configuration of the image forming system 100 similar to the configuration described in the first exemplary embodiment are omitted.

Hereinafter, image adjustment control according to the present exemplary of waste sheets can be suppressed by application of the following configuration.

In the present exemplary embodiment, the CPU 201 counts the number of sheets where the images are formed, and executes the image adjustment control every time image formation is executed on the sheets of an adjustment sheet count (e.g., 100 sheets) in a print job. In addition, the adjustment sheet count is a value greater than a prescribed number.

Further, in the present exemplary embodiment, in a case where the rejection whose details are “positional deviation” has occurred in a prescribed number of sheets before a sheet count of the sheets where image formation is executed reaches the adjustment sheet count, the CPU 201 executes the image adjustment control and also shortens the execution interval of the image adjustment control. Specifically, a smaller sheet count (e.g., 95 sheets) is set as the adjustment sheet count.

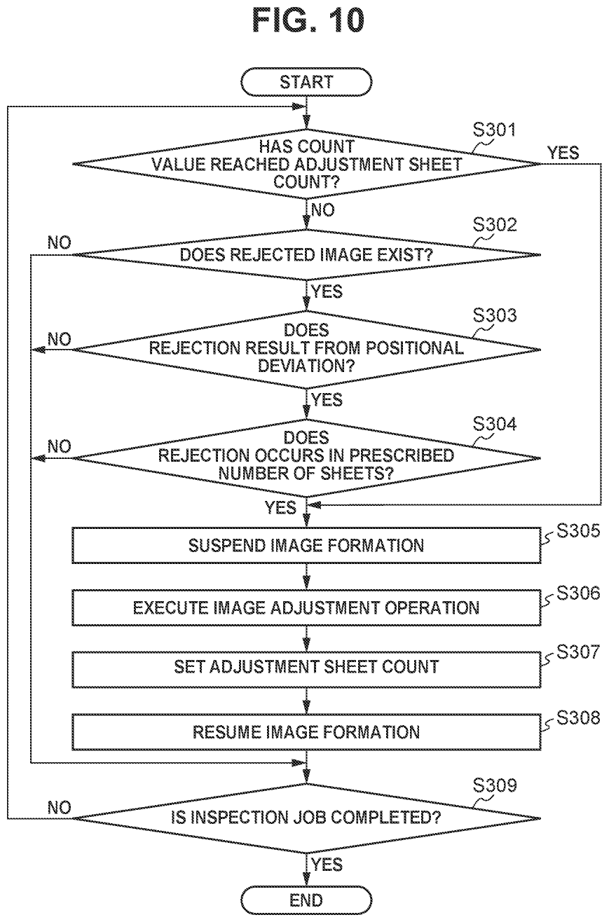

FIG. 10 is a flowchart illustrating image inspection control including the image adjustment control. The flowchart in FIG. 10 is executed by the CPU 201 when an inspection job for inspecting the images formed on the sheets is executed. The inspection job according to the present exemplary embodiment is a print job which includes image inspection. In the image inspection control illustrated in FIG. 10, descriptions of the processing for forming the images on the sheets executed by the image forming apparatus 30 and the processing for reading the images formed on the sheets executed by the inspection apparatus 50 are omitted. For example, the sheets on which the images are formed by the image forming apparatus 30 are sequentially read by the inspection apparatus 50 while a print job (inspection job) for printing a plurality of images on a plurality of sheets is being executed by the image forming apparatus 30. Further, in the image inspection control according to the present exemplary embodiment, image adjustment control is executed every time the images are formed on the sheets of the adjustment sheet count. In the following descriptions, the CPU 201 of the control apparatus 40 executes the image inspection control while a print job (inspection job) for printing a plurality of images on a plurality of sheets is being executed by the image forming apparatus 30.

In step S301, when the count value of the CPU 201 has reached the adjustment sheet count (YES in step S301), the processing proceeds to step S305.

On the other hand, in step S301, when the count value of the CPU 201 has not reached the adjustment sheet count (NO in step S301), the processing proceeds to step S302.

In step S302, in a case where the evaluation unit 304 determines that an image formed on a sheet is rejected (YES in step S302), the processing proceeds to step S303.

In step S303, in a case where the details of rejection are “positional deviation” (YES in step S303), the processing proceeds to step S304.

On the other hand, in step S303, in a case where the details of rejection are not “positional deviation” (NO in step S303), the processing proceeds to step S309.

In step S304, in a case where the rejection whose details are “positional deviation” occurs in a prescribed number of sheets (e.g., 5 sheets) (YES in step S304), the processing proceeds to step S305. In step S305, the CPU 201 suspends the processing for forming the images on the sheets executed by the image forming apparatus 30. Then, the CPU 201 controls the various apparatuses to make the sheets remaining in the image forming system 100 be discharged to the outside, such as the sheet tray 62a.

On the other hand, in step S304, in a case where the rejection whose details are “positional deviation” does not occur in a prescribed number of sheets (NO in step S304), the processing proceeds to step S309.

In step S306, the CPU 201 executes the image adjustment operation. Specifically, the CPU 201 controls the image forming apparatus 30 to form the adjustment chart on a sheet, and controls the inspection apparatus 50 to read the adjustment chart formed thereon. Based on the read result acquired by the inspection apparatus 50, the image forming apparatus 30 sets the image forming condition again through the method described above.

In step S307, the CPU 201 sets the adjustment sheet count to a sheet count smaller than a sheet count of the current setting. The CPU 201 sets a sheet count acquired by subtracting a prescribed sheet count from a sheet count of the current setting as the adjustment sheet count.

Thereafter, in step S308, the CPU 201 resumes the inspection job (i.e., resumes the formation of the images on the sheets).

In step S309, in a case where the inspection job is completed (YES in step S309), the CPU 201 ends the processing illustrated in this flowchart.

Further, in step S309, in a case where the inspection job is not completed (NO in step S309), the processing returns to step S301.

As described above, according to the present exemplary embodiment, in a case where the rejection whose details are “positional deviation” has occurred in a prescribed number of sheets before the sheet count of the sheets where image formation is executed reaches the adjustment sheet count, the CPU 201 executes the image adjustment control and also shortens the execution interval of the image adjustment control. As a result, occurrence of the image defect can be suppressed. Further, according to the present exemplary embodiment, it is possible to suppress generation of waste sheets.

In addition, image adjustment control may be executed every time image formation of a prescribed number of pages is executed in a print job.

Descriptions of the configuration of the image forming system 100 similar to the configuration described in the first exemplary embodiment are omitted.

Hereinafter, image adjustment control according to the present exemplary of waste sheets can be suppressed by application of the following configuration.

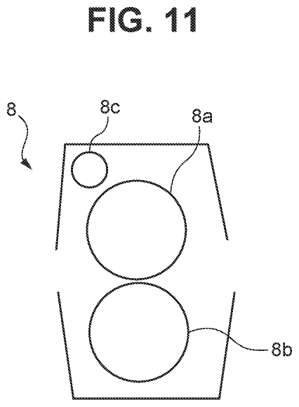

FIG. 11 is a diagram illustrating a configuration of the fixing device 8 according to the present exemplary embodiment. As illustrated in FIG. 11, the fixing device 8 includes a heating roller 8a, a pressure roller 8b, and a refresh roller 8c. In FIG. 11, illustration of a heater for heating up the heating roller 8a is omitted.

The heating roller 8a and the pressure roller 8b fix a toner image transferred to a sheet while nipping and conveying the sheet.

### <Refresh Roller>

The refresh roller 8c can be in contact with and separated from the heating roller 8a. The refresh roller 8c is described below.

When the sheet is nipped and conveyed by the heating roller 8a and the pressure roller 8b, an edge portion thereof in a width direction of the sheet may cause an edge surface to be created on each of the heating roller 8a and the pressure roller 8b formed of elastic members. There is a case where a streak-like image is generated in the fixed image if a toner image is fixed to the sheet in a state where the edge surfaces are created on the rollers 8a and 8b.

Therefore, according to the present exemplary embodiment, irregularities of the edge surfaces can be flattened by rotation of the refresh roller 8c and the heating roller 8a in a state where the refresh roller 8c is in contact with the heating roller 8a. As a result, it is possible to suppress generation of a streak-like image.

### <Cleaning Image Sensor Glass>

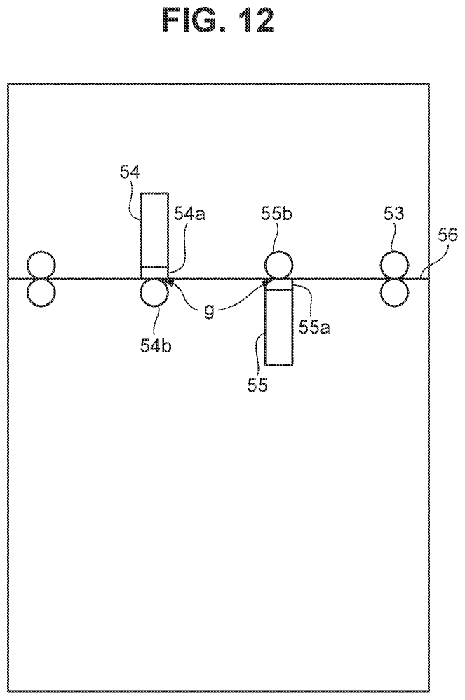

FIG. 12 is a schematic cross-sectional diagram illustrating constituent elements located in vicinities of the image sensors 54 and 55 of the inspection apparatus 50. The conveyance rollers 53 convey a sheet received from the image forming apparatus 30 to a conveyance path 56. The image sensor 54 has a glass surface 54a which transmits reflection light from the sheet at a position between the image sensor 54 and the conveyance path 56. A backing roller 54b is arranged on one side of the conveyance path 56 opposite to another side where the glass surface 54a is located. The image sensor 54 reads a surface of the sheet conveyed along the conveyance path 56 which faces the glass surface 54a. Similarly, the image sensor 55 has a glass surface 55a which transmits reflection light from the sheet at a position between the image sensor 55 and the conveyance path 56. A backing roller 55b is arranged on one side of the conveyance path 56 opposite to another side where the glass surface 55a is located. The image sensor 55 reads a surface of the sheet conveyed along the conveyance path 56 which faces the glass surface 55a. In addition, white rollers are used as the backing rollers 54b and 55b of the present exemplary embodiment.

Herein, dust such as paper dust, indicated by a symbol “g” in FIG. 12, generated from the sheet conveyed along the conveyance path 56, may adhere to the glass surfaces 54a and 55a. In a case where dust adheres to at least any one of the glass surfaces 54a and 55a, a streak-like image appears on a read image read by the image sensors 54 and 55 even if the streak-like image is not formed on the actual sheet. Because of the above-described situation, the inspection apparatus 50 (or the control apparatus 40) cannot correctly execute the image inspection.

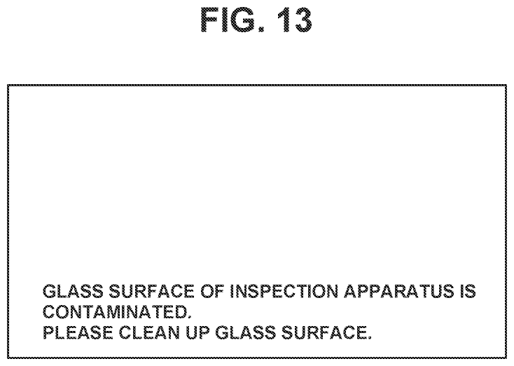

A housing of the inspection apparatus 50 according to the present exemplary embodiment has a mechanical structure which enables a part of the housing located on the upper side of the conveyance path 56 in a gravity direction (i.e., upper part) to be separated from a portion thereof located on the lower side of the conveyance path 56 in the gravitation direction (i.e., lower part). Therefore, in a case where dust adheres to the glass surface 54a or 55a, for example, the user can clean up the glass surface 54a or 55a by separating the upper part from the lower part thereof. In a case where a streak-like image is generated because of the firmly-adhered dust, the CPU 201 of the control apparatus 40 according to the present exemplary embodiment displays a screen (FIG. 13) for prompting the user to clean up the glass surface on the display device 21.

### <Determining Cause of Streak-Like Image>

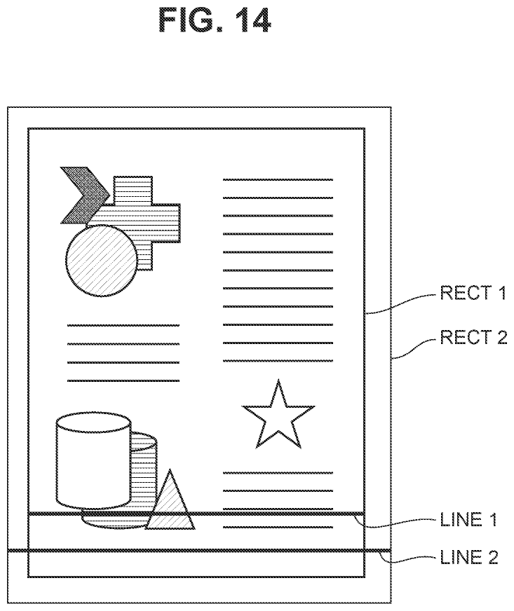

FIG. 14 is a diagram illustrating a streak-like image appearing in an image read by the image sensor 54. An area rect 1 is an area corresponding to a sheet included in a read image read by the image sensor 54, and an area rect 2 represents a read image read by the image sensor 54. The read image includes the sheet and the area on the outside of the outer edge of the sheet. In FIG. 14, a streak-like image line 1 appears in the area inside of the sheet, and a streak-like image line 2 appears in the area beyond the area of the sheet. In other words, a streak-like image line 1 caused by the edge surfaces created on the heating roller 8a and the pressure roller 8b is generated only on the sheet. Therefore, the streak-like image line 1 appears in the area inside of the sheet. On the other hand, the streak-like image line 2 caused by dust firmly adhering to the glass surface 54a is generated in the area beyond the area of the sheet. Therefore, the evaluation unit 304 determines that the streak-like image line 1 appearing in the area rect 1 is a streak-like image generated because of the edge surfaces created on the heating roller 8a and the pressure roller 8b. Further, the evaluation unit 304 determines that the streak-like image line 2 appearing in the area rect 2 beyond the area rect 1 is a streak-like image generated because of dust firmly adhering thereto.

### <Execution Timing of Image Adjustment Control>

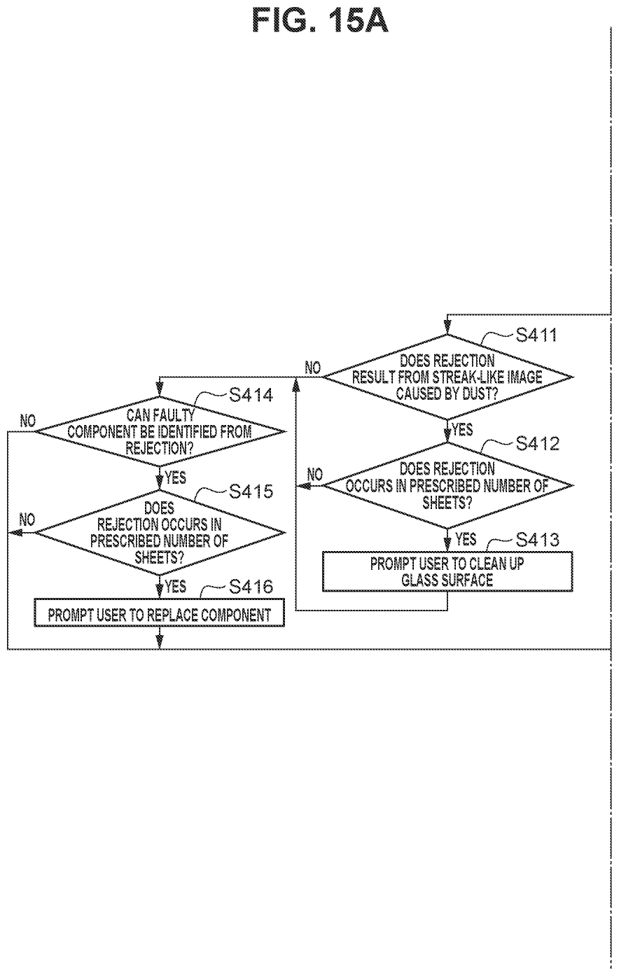

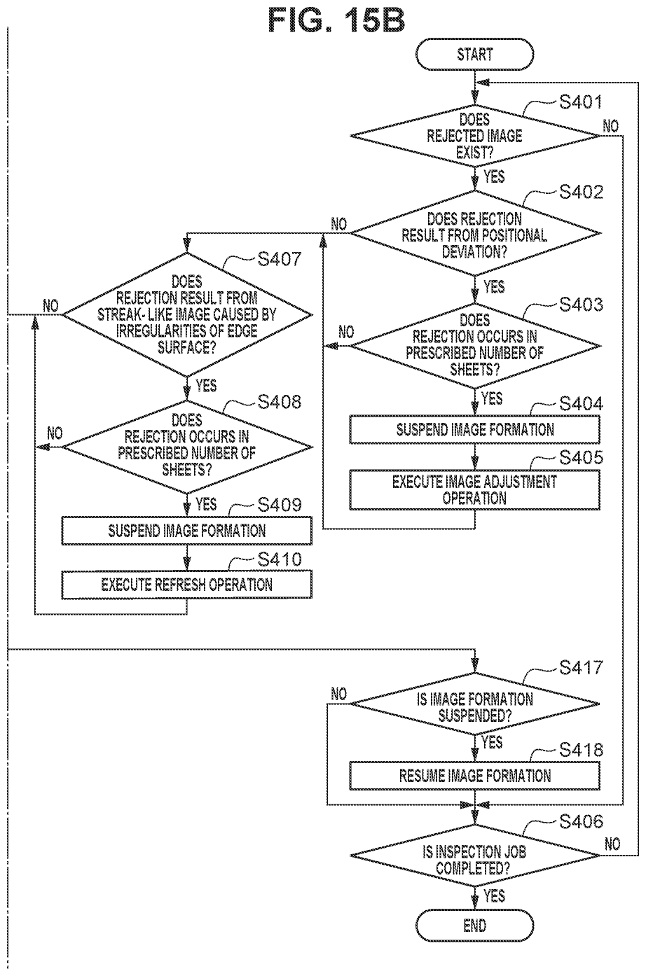

FIGS. 15A and 15B are a flowchart illustrating image inspection control including the image adjustment control. The flowchart in FIGS. 15A and 15B is executed by the CPU 201 when a job for inspecting the images formed on the sheets is executed. The inspection job according to the present exemplary embodiment is a print job which includes image inspection. In the image inspection control illustrated in FIGS. 15A and 15B, descriptions of the processing for forming the images on the sheets executed by the image forming apparatus 30 and the processing for reading the images formed on the sheets executed by the inspection apparatus 50 are omitted. For example, the sheets on which the images are formed by the image forming apparatus 30 are sequentially read by the inspection apparatus 50 while a print job (inspection job) for printing a plurality of images on a plurality of sheets is being executed by the image forming apparatus 30. In the following descriptions, the CPU 201 of the control apparatus 40 executes the image inspection control while a print job (inspection job) for printing a plurality of images on a plurality of sheets is being executed by the image forming apparatus 30.

When a sheet image corresponding to one page is acquired by the image sensors 54 and 55, in step S401, the CPU 201 determines whether a determination result acquired by the evaluation unit 304 indicates rejection. In a case where the CPU 201 determines that the determination result indicates rejection (YES in step S401) the processing proceeds to step S402. In step S402, the CPU 201 determines whether the details of rejection are “positional deviation”. In step S402, in a case where the details of rejection are “positional deviation” (YES in step S402), the processing proceeds to step S403. In step S403, the CPU 201 determines whether the rejection whose details are “positional deviation” has occurred in a prescribed number of sheets (e.g., 5 sheets). In step S403, in a case where the rejection whose details are “positional deviation”, indicated by the inspection result acquired by the evaluation unit 304, has occurred in a prescribed number of sheets (YES in step S403), the processing proceeds to step S404. In step S404, the CPU 201 controls the image forming apparatus 30 to suspend the processing for forming the images on the subsequent sheets based on a print job. Then, in step S405, in order to execute the image adjustment control, the CPU 201 controls the image forming apparatus 30 to print the adjustment chart (FIG. 6) different from the above-described print job. The adjustment chart formed thereon is read by the inspection apparatus 50. Based on the read result of the adjustment chart, the CPU 201 generates an image forming condition for adjustment of a position, an inclination angle, and a magnification ratio of the image to be formed on a sheet.

Further, in step S402, in a case where the details of rejection are not “positional deviation” (NO in step S402), the processing proceeds to step S407. In step S407, the CPU 201 determines whether the details of rejection are “a streak-like image caused by irregularities of the edge surface”. In step S407, in a case where the details of rejection are “a streak-like image caused by irregularities of the edge surface” (YES in step S407), the processing proceeds to step S408. In step S408, the CPU 201 determines whether rejection whose details are “a streak-like image caused by irregularities of the edge surface” has occurred in a prescribed number of sheets (e.g., 5 sheets). In step S408, in a case where the rejection whose details are “a streak-like image caused by irregularities of the edge surface”, indicated by the inspection result acquired by the evaluation unit 304, has occurred in a prescribed number of sheets (YES in step S408), the processing proceeds to step S409. In step S409, the CPU 201 controls the image forming apparatus 30 to suspend the processing for forming the images on the subsequent sheets based on a print job. Then, in step S410, the CPU 201 controls the image forming apparatus 30 to execute the refresh operation. Specifically, the CPU 201 brings the refresh roller 8c into contact with the heating roller 8a, rotates the refresh roller 8c and the heating roller 8a for a prescribed time (e.g., 10 sec.), and removes the refresh roller 8c therefrom.

Further, in step S403, in a case where rejection whose details are “positional deviation”, indicated by the inspection result acquired by the evaluation unit 304, has not occurred in a prescribed number of sheets (NO in step S403), the CPU 201 also advances the processing to step S407. Further, after the image adjustment operation is executed in step S405, the CPU 201 advances the processing to step S407.

Further, in step S407, in a case where the details of rejection are not “a streak-like image caused by irregularities of the edge surface” (NO in step S407), the processing proceeds to step S411. In step S411, the CPU 201 determines whether the details of rejection are “a streak-like image caused by dust adhering to the glass surface”. In step S411, in a case where the details of rejection are “a streak-like image caused by dust adhering to the glass surface” (YES in step S411), the processing proceeds to step S412. In step S412, the CPU 201 determines whether rejection whose details are “a streak-like image caused by dust adhering to the glass surface” has occurred in a prescribed number of sheets (e.g., 5 sheets). In step S412, in a case where the rejection whose details are “a streak-like image caused by dust adhering to the glass surface”, indicated by the inspection result acquired by the evaluation unit 304, has occurred in a prescribed number of sheets (YES in step S412), the processing proceeds to step S413. In step S413, the CPU 201 displays a screen (FIG. 13) prompting the user to clean up the glass surface on the display device 21, without suspending the processing for forming the images on the subsequent sheets based on a print job.

In step S408, in a case where the rejection whose details are “a streak-like image caused by irregularities of the edge surface”, indicated by the inspection result acquired by the evaluation unit 304, has not occurred in a prescribed number of sheets (NO in step S408), the CPU 201 also advances the processing to step S411. Further, after the refresh operation is executed in step S410, the CPU 201 advances the processing to step S411.

Further, in step S411, in a case where the details of rejection are not “a streak-like image caused by dust adhering to the glass surface” (NO in step S411), the processing proceeds to step S414. In step S414, the CPU 201 determines whether the details of rejection are “a faulty component identifiable from the rejection”. For example, in a case where a black dot appears in a read image at an interval corresponding to the circumferential length of the transfer roller 5Y, it is thought that the black dot is generated because of contamination or aging degradation of the transfer roller 5Y. In this case, occurrence of this rejection may be suppressed by replacement of the transfer roller 5Y. Therefore, in step S414, in a case where the details of rejection are “a faulty component identifiable from the rejection” (YES in step S414), the processing proceeds to step S415. In step S415, the CPU 201 determines whether rejection whose details are “a faulty component identifiable from the rejection” has occurred in a prescribed number of sheets (e.g., 5 sheets). In step S415, in a case where the rejection whose details are “a faulty component identifiable from the rejection” has occurred in a prescribed number of sheets (e.g., 5 sheets) (YES in step S415), the processing proceeds to step S416. In step S416, the CPU 201 displays a screen prompting the user to replace a corresponding component on the display device 21.

Further, in step S412, in a case where the rejection whose details are “a streak-like image caused by dust adhering to the glass surface”, indicated by the inspection result acquired by the evaluation unit 304, has not occurred in a prescribed number of sheets (NO in step S412), the CPU 201 also advances the processing to step S414. After the screen (FIG. 13) prompting the user to clean up the glass surface is displayed on the display device 21 in step S413, the CPU 201 advances the processing to step S414.

In step S414, in a case where the details of rejection are not “a faulty component identifiable from the rejection” (NO in step S414), the processing to step S417. In step S417, the CPU 201 determines whether the image forming operation is suspended. In step S415, in a case where the rejection whose details are “a faulty component identifiable from the rejection” has not occurred in a prescribed number of sheets (e.g., 5 sheets) (NO in step S415), the CPU 201 also advances the processing to step S417. Further, after the screen prompting the user to replace a corresponding component is displayed on the display device 21 in step S416, the CPU 201 also advances the processing to step S417. In step S417, in a case where image formation is suspended (YES in step S417), the processing proceeds to step S418. In step S418, the CPU 201 controls the image forming apparatus 30 to resume the image formation based on the print job (inspection job). Then, in step S406, the CPU 201 determines whether inspection of all of images included in the inspection job has been completed.

Further, in a case where the CPU 201 does not determine that an image formed on the sheet is a reject (NO in step S401), the processing proceeds to step S406. In step S406, the CPU 201 determines whether inspection of all of images included in the inspection job has been completed. In step S406, in a case where inspection of not all of the images included in the inspection job has been completed (NO in step S406), the CPU 201 advances the processing to step S401. On the other hand, in a case where inspection of all of the images included in the inspection job has been completed (YES in step S406), the CPU 201 ends the image inspection control. In the present exemplary embodiment, the above-described refresh operation is executed when rejection whose details are “a streak-like image” has occurred in a prescribed number of sheets. In other words, according to the present exemplary embodiment, the image adjustment control is executed in a case where the evaluation unit 304 determines occurrence of rejection caused by the inspection item which can be corrected by the image adjustment control, and the refresh operation is executed when the evaluation unit 304 determines occurrence of rejection caused by the inspection item which can be corrected by the refresh operation. As a result, it is possible to suppress generation of waste sheets. Further, the frequency of occurrence of rejection can be reduced, and generation of rejected sheets (waste sheets) can also be suppressed.

In the present exemplary embodiment, coping operations including the image adjustment control, the refresh operation, and the image inspection control are executed when a similar type of rejection has occurred in a prescribed number of sheets (read images). However, the present disclosure is not limited thereto. For example, the image adjustment control may be executed in a case where rejection whose details are “a streak-like image” has consecutively occurred in a prescribed number of sheets.

Further, for example, the image adjustment control may be executed in a case where rejection whose details are “a streak-like image” has occurred in a sheet. In addition, this prescribed number can be set by the user through the input device 22.

The image forming system 100 according to the present exemplary embodiment suspends the image forming operation, executes abnormality recovery processing, and resumes the image forming operation after that, when a print job (inspection job) is being executed. Therefore, the image forming system 100 according to the present exemplary embodiment can suppress generation of a large number of abnormal images while suppressing a decline in productivity of the image forming apparatus 30.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-062989, filed Apr. 7, 2023, which is hereby incorporated by reference herein in its entirety.

What is claimed is:

1. An image forming system comprising:
an image forming apparatus configured to form an image on a sheet;
a reading apparatus configured to read the image formed on the sheet conveyed from the image forming apparatus;
an inspection unit configured to inspect the image read by the reading apparatus to detect defect on the image; and
a controller configured to:
control, in a case where a first type of defect is detected by the inspection unit during formation of a plurality of images by the image forming apparatus, the image forming apparatus to stop the formation, and execute an adjustment operation for adjusting a quality of an image to be formed by the image forming apparatus, and
control, in a case where a second type of defect is detected by the inspection unit during the formation of the plurality of images by the image forming apparatus, the image forming apparatus to continue the formation, wherein the second type of defect is different from the first type of defect.

2. The image forming system according to claim 1 further comprising:
a setting unit configured to set an image forming condition to be applied when the image forming apparatus forms the plurality of images on the sheets, based on second image data acquired by reading a test chart by the reading apparatus, the test chart being formed by the image forming apparatus,
wherein the image forming apparatus starts forming the plurality of images on the sheets based on the image forming condition which is set based on the second image data.

3. The image forming system according to claim 1, wherein the controller, in a case where a consecutive number of sheets having an image on which a first type of defect is detected by the inspection unit during formation of a plurality of images by the image forming apparatus reaches a predetermined number, controls the image forming apparatus to stop the formation and executes the adjustment operation.

4. The image forming system according to claim 1,
wherein, in a case where an amount of positional deviation of the image read by the reading apparatus with respect to an image corresponding to reference data, is a prescribed value or more, the inspection unit detects the first type of defect on the image, and
wherein the quality of an image to be formed by the image forming apparatus is the amount of positional deviation.

5. The image forming system according to claim 1, wherein, in a case where a noise image which does not exist in an image corresponding to reference data exists in the image read by the reading apparatus, the inspection unit detects the second type of defect on the image.

6. The image forming system according to claim 5, wherein the noise image is a streak.

7. The image forming system according to claim 5, wherein the noise image is a black dot.
